(19) United States
(12) Patent Application Publication
(10) Pub. No.: US 2021/0127405 A1
(43) Pub. Date: Apr. 29, 2021

(54) METHOD, DEVICE, AND APPARATUS FOR REDUCING INTERFERENCE FROM COEXISTENCE OF MULTIPLE RADIO TECHNOLOGIES

(71) Applicant: ZTE CORPORATION, Shenzhen, Guangdong (CN)

(72) Inventors: Wei Ma, Shenzhen, Guangdong (CN); Guoqiang Shang, Shenzhen, Guangdong (CN); Yaying Wang, Shenzhen, Guangdong (CN); Yong Lv, Shenzhen, Guangdong (CN); Jianfeng Ding, Shenzhen, Guangdong (CN)

(21) Appl. No.: 16/490,098

(22) PCT Filed: Nov. 1, 2017
(86) PCT No.: PCT/CN2017/108914

§ 371 Date: Aug. 30, 2019

(30) Foreign Application Priority Data
Mar. 17, 2017 (CN) 201710161421.6

(51) Int. Cl. H04W 72/12; H04W 72/04

(52) U.S. Cl. CPC H04W 72/1215; H04W 72/0413; H04W 72/1268; H04W 72/1231

(57) ABSTRACT

Disclosed are a method, an apparatus, and a device for reducing interference from coexistence of multiple radio technologies. The method includes: a terminal sets up an uplink scheduling request SR message carrying in-device coexistence IDC information, the IDC information being configured for a network side to allocate an uplink resource to the terminal; and the terminal transmits the SR message.

### FIELD OF THE INVENTION

The present disclosure relates to the technical field of mobile communications, and in particular, to a method, an apparatus, and a device for reducing interference from coexistence of multiple radio technologies.

### BACKGROUND OF THE INVENTION

As the demand for radio communications continuously increases, a radio communication device (such as a smart mobile terminal) is equipped with a variety of radio transceivers that support different radio technologies, and forms a multiple radio terminal (MRT). The MRT may be provided simultaneously therein with a long term evolution (LTE) or LTE-advanced (LTE-A) radio transceiver, a wireless local area network (WLAN) access radio transceiver, a Bluetooth radio transceiver, a global navigation satellite system radio transceiver, etc. The phenomenon of the co-location or coexistence of multiple radio transceivers in a same communication device (MRT) is called in-device coexistence (IDC).

From a perspective of spectrum rule, different radio technologies may operate on overlapping or adjacent radio spectra. Because of simultaneous operation of multiple radio transceivers of MRT on overlapping or adjacent wireless spectra, when data transmission for a first radio transceiver overlaps in time domain with data reception for a second radio transceiver, the data reception for the second radio transceiver may be interfered with by the data transmission for the first radio transceiver. Likewise, the data transmission for the second radio transceiver may also be interfered with by the data reception for the first radio transceiver.

Some radio resource management techniques are proposed in LTE/LTE-A systems to eliminate the aforementioned interference. An example is to reduce interference with a radio communication signal by disabling other communication signals. Although this approach reduces the interference, it leads to interruption of other communication systems, thus failing to guarantee the quality of all communications. In addition, two radio resource control states may be defined in an LTE user equipment (UE), namely an active state and an idle state. If the LTE UE is in the active state, the network may avoid switching the UE to a frequency/frequency band having interference, or may switch the UE to a cell having better signal measurement; and if the UE is in the idle state, the UE avoids residing at a frequency (frequency band) having significant interference. This approach requires detections of the state of the LTE UE, and is thus waste of communication resources due to frequent interacting procedures of detection.

### SUMMARY OF THE INVENTION

In order to solve those related existing technical problems, embodiments of the present disclosure provide a method, an apparatus, and a device for reducing interference from coexistence of multiple radio technologies.

To achieve the above objective, the technical solutions embodied by embodiments of the present disclosure are achieved as below.

An embodiment of the present disclosure provides a method for reducing interference from coexistence of multiple radio technologies including: setting up, by a terminal, an uplink scheduling request SR message carrying IDC information, the IDC information being configured for a network side to allocate an uplink resource to the terminal; and transmitting, by the terminal, the SR message.

The IDC information includes one or more of:

in-device coexistence indication information, receiving frequency domain information of other in-device coexisting radio technologies other than LTE/NR, receiving time domain information of other in-device coexisting radio technologies other than the LTE/NR, transmitting frequency domain information of other in-device coexisting radio technologies other than the LTE/NR, transmitting time domain information of other in-device coexisting radio technologies other than the LTE/NR, in-device coexisting time domain allocation information, in-device coexisting frequency domain allocation information.

Alternatively, after the terminal transmits the SR message, the method further includes:

receiving, by the terminal, feedback information about the SR message issued from the network side, and performing, by the terminal, communication based on the uplink resource allocated by the network side which is carried in the feedback information.

The uplink resource allocated to the terminal by the network side is separated in time domain or frequency domain by an interval from time domain or frequency domain of other radio technologies other than LTE/NR.

An embodiment of the present disclosure further provides a method for reducing interference from coexistence of multiple radio technologies, including:

receiving, by a network side, an SR message carrying IDC information; and

allocating, by the network side, an uplink resource to a terminal based on the IDC information.

Alternatively, after the network side allocates the uplink resource to the terminal, the method further includes:

issuing, by the network side, feedback information about the SR message to the terminal, the feedback information carrying the uplink resource allocated to the terminal.

The uplink resource allocated to the terminal by the network side is separated in time domain or frequency domain by an interval from time domain or frequency domain of other radio technologies other than LTE/NR.

An embodiment of the present disclosure further provides an apparatus for reducing interference from coexistence of multiple radio technologies, including:

a setting up module, configured to set up an SR message carrying in-device coexistence IDC information, the IDC information being configured for a network side to allocate an uplink resource to a terminal, and

a first transmitting module, configured to transmit the SR message.

Alternatively, the apparatus further includes:

a receiving and processing module, configured to receive feedback information about the SR message issued from the network side, and perform communication based on the uplink resource allocated by the network side which is carried in the feedback information.

The uplink resource allocated to the terminal by the network side is separated in time domain or frequency domain by an interval from time domain or frequency domain of other radio technologies other than LTE/NR.

An embodiment of the present disclosure further provides a terminal device. The terminal device includes the aforementioned apparatus for reducing interference from coexistence of multiple radio technologies.

An embodiment of the present disclosure further provides an apparatus for reducing interference from coexistence of multiple radio technologies, including:

a receiving module, configured to receive an SR message carrying IDC information, and

an allocating module, configured to allocate an uplink resource to a terminal based on the IDC information.

Alternatively, the apparatus further includes:

a second transmitting module, configured to issue feedback information about the SR message to the terminal, the feedback information carrying the uplink resource allocated to the terminal.

The uplink resource allocated to the terminal by the network side is separated in time domain or frequency domain by an interval from time domain or frequency domain of other radio technologies other than LTE/NR.

An embodiment of the present disclosure further provides a network device. The network device includes the aforementioned apparatus for reducing interference from coexistence of multiple radio technologies.

An embodiment of the present disclosure further provides a storage medium configured to store program codes which are used for performing any of the abovementioned methods.

The embodiments of the present disclosure provide a method, an apparatus, and a device for reducing interference from coexistence of multiple radio technologies. The method includes: setting up, by a terminal, an SR message carrying IDC information, the IDC information being configured for a network side to allocate an uplink resource to the terminal; and transmitting, by the terminal, the SR message. In the embodiments of the present disclosure, the terminal reports the IDC information to the network side, so that the network side schedules frequency domain or the time domain of different radio technology communications in a separate manner based on the IDC information, by way of which the different radio technology communications can be carried out simultaneously. Thus, the communication quality of each communication can be guaranteed, and user experience is thus improved.

### BRIEF DESCRIPTION OF THE DRAWINGS

FIG. 1 is a first flowchart of a method for reducing interference from coexistence of multiple radio technologies according to an embodiment of the present disclosure;

FIG. 2 is a second flowchart of a method for reducing interference from coexistence of multiple radio technologies according to an embodiment of the present disclosure;

FIG. 3 is a first schematic structural diagram of an apparatus for reducing interference from coexistence of multiple radio technologies according to an embodiment of the present disclosure;

FIG. 4 is a second schematic structural diagram of an apparatus for reducing interference from coexistence of multiple radio technologies according to an embodiment of the present disclosure;

FIG. 5 is a third schematic structural diagram of an apparatus for reducing interference from coexistence of multiple radio technologies according to an embodiment of the present disclosure;

FIG. 6 is a fourth schematic structural diagram of an apparatus for reducing interference from coexistence of multiple radio technologies according to an embodiment of the present disclosure;

FIG. 7 is a schematic structural diagram of a terminal according to a scenario embodiment of the present disclosure;

FIG. 8 is a first flowchart of a method for reducing interference from coexistence of multiple radio technologies according to the scenario embodiment of the present disclosure; and

FIG. 9 is a second flowchart of the method for reducing interference from coexistence of multiple radio technologies according to the scenario embodiment of the present disclosure.

### DETAILED DESCRIPTION OF THE EMBODIMENTS

The present disclosure is described in detail below in connection with exemplary embodiments.

An embodiment of the present disclosure provides a method for reducing interference from coexistence of multiple radio technologies. As shown in FIG. 1, the method includes the following steps.

In Step 101, a terminal sets up an SR message carrying IDC information, the IDC information being configured for a network side to allocate an uplink resource to the terminal.

In Step 102, the terminal transmits the SR message.

In the present embodiment, the terminal may be a mobile phone, a personal digital assistant (PDA), a smart handheld device, a laptop computer, a tablet computer, or the like.

In the present embodiment, the IDC information includes one or more of: in-device coexistence indication information (e.g., indicating whether there are other radio technologies coexisting with LTE/NR (New Air Interface) within the terminal), receiving frequency domain information of other in-device coexisting radio technologies other than the LTE/NR, receiving time domain information of other in-device coexisting radio technologies other than the LTE/NR, transmitting frequency domain information of other in-device coexisting radio technologies other than the LTE/NR, transmitting time domain information of other in-device coexisting radio technologies other than the LTE/NR, in-device coexisting time domain allocation information, and in-device coexisting frequency domain allocation information.

In the present embodiment, after the terminal transmits the SR message, the method further includes the following step.

The terminal receives a feedback information about the SR message issued from the network side, and performs communication based on the uplink resource allocated by the network side which is carried in the feedback information.

In the present embodiment, the uplink resource allocated to the terminal by the network side is separated in time domain or frequency domain by an interval from time domain or frequency domain of other radio technologies other than the LTE/NR. Here, the uplink resource allocated to the terminal by the network side is described in more detail in the following embodiments.

In the present embodiment, the terminal reports the IDC information to the network side, so that the network side schedules frequency domain or time domain of different radio technology communications in a separate manner based on the IDC information, by way of which the different radio technology communications can be carried out simultaneously. Thus, the communication quality of each communication can be guaranteed, and user experience is thus improved.

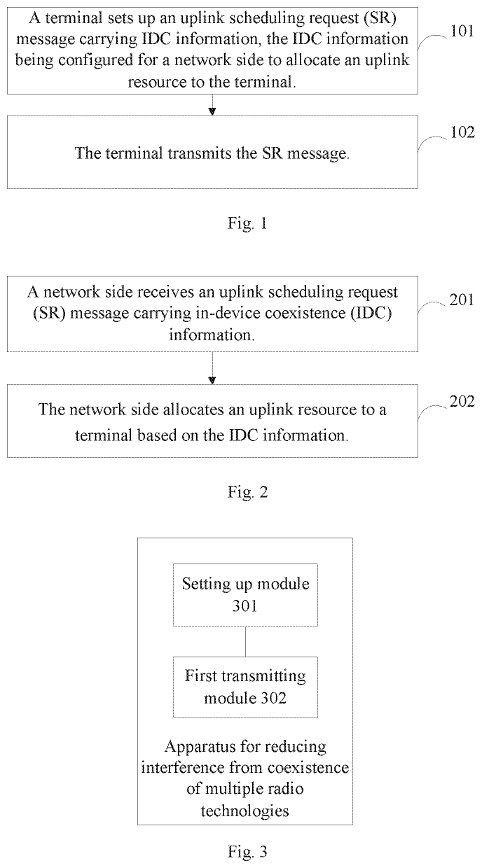

An embodiment of the present disclosure provides a further method for reducing interference from coexistence of multiple radio technologies as shown in FIG. 2, the method includes the following steps.

In Step 201, a network side receives an SR message carrying IDC information.

In Step 202, the network side allocates an uplink resource to a terminal based on the IDC information.

In the present embodiment, the terminal may be a mobile phone, a PAD, a smart device, a laptop computer, a tablet computer, or the like.

In the present embodiment, the IDC information includes one or more of: in-device coexistence indication information (e.g., indicating whether there are other radio technologies coexisting with LTE/NR (New Air Interface) within the terminal), receiving frequency domain information of other in-device coexisting radio technologies other than the LTENR, receiving time domain information of other in-device coexisting radio technologies other than the LTE/NR, transmitting frequency domain information of other in-device coexisting radio technologies other than the LTENR, transmitting time domain information of other in-device coexisting radio technologies other than the LTE/NR, in-device coexisting time domain allocation information, and in-device coexisting frequency domain allocation information.

In the present embodiment, after the network side allocates the uplink resource to the terminal, the method further includes the following step.

The network side issues feedback information about the SR message to the terminal, the feedback information carrying the uplink resource allocated to the terminal.

Here, the uplink resource allocated to the terminal by the network side is separated in time domain or frequency domain by an interval from time domain or frequency domain of other radio technologies other than the LTENR.

In the present embodiment, the terminal reports the IDC information to the network side, so that the network side schedules frequency domain or time domain of different radio technology communications in a separate manner based on the IDC information, by way of which the different radio technology communications can be carried out simultaneously. Thus, the communication quality of each communication can be guaranteed, and user experience is thus improved.

An embodiment of the present disclosure further provides an apparatus for reducing interference from coexistence of multiple radio technologies. The apparatus is configured to implement the above embodiments and the preferred embodiments. Those have been described will not be described herein in detail. As used below, terms “module” and “unit” may implement a combination of software and/or hardware with a predetermined function. As shown in FIG. 3, the apparatus includes: a setting up module 301, configured to set up an uplink scheduling request SR message carrying IDC information, the IDC information being configured for a network side to allocate an uplink resource to a terminal; and a first transmitting module 302, configured to transmit the SR message.

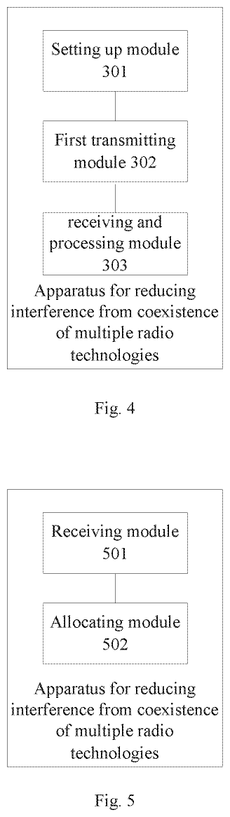

In the present embodiment, as shown in FIG. 4, the apparatus further includes: a receiving and processing module 303, configured to receive feedback information about the SR message issued from the network side and perform communications based on the uplink resource allocated by the network side which is carried in the feedback information.

In the present embodiment, the IDC information includes one or more of: in-device coexistence indication information (e.g., indicating whether there are other radio technologies coexisting with LTE/NR (New Air Interface) within the terminal), receiving frequency domain information of other in-device coexisting radio technologies other than the LTE/NR, receiving time domain information of other in-device coexisting radio technologies other than the LTE/NR, transmitting frequency domain information of other in-device coexisting radio technologies other than the LTENR, transmitting time domain information of other in-device coexisting radio technologies other than the LTE/NR, in-device coexisting time domain allocation information, and in-device coexisting frequency domain allocation information.

Here, the uplink resource allocated to the terminal by the network side is separated in time domain or frequency domain by an interval from time domain or frequency domain of other radio technologies other than the LTF/NR.

In practical applications, the setting up module 301 and the receiving and processing module 303 may be a central processing unit (CPU), a digital signal processor (DSP), a field programmable gate array (FPGA), and the like in the terminal; and the first transmitting module 302 may be an antenna corresponding to a related communication module in the terminal.

An embodiment of the present disclosure provides a further apparatus for reducing interference from coexistence of multiple radio technologies as shown in FIG. 5, the apparatus includes:

a receiving module 501, configured to receive an SR message carrying IDC information; and

an allocating module 502, configured to allocate uplink resource to a terminal based on the IDC information.

In the present embodiment, the IDC information includes one or more of: in-device coexistence indication information (e.g., indicating whether there are other radio technologies coexisting with LTE/NR (New Air Interface) in the terminal), receiving frequency domain information of other in-device coexisting radio technologies other than the LTENR, receiving time domain information of other in-device coexisting radio technologies other than the LTE/NR, transmitting frequency domain information of other in-device coexisting radio technologies other than the LTE/NR, transmitting time domain information of other in-device coexisting radio technologies other than the LTE/NR, in-device coexisting time domain allocation information, and in-device coexisting frequency domain allocation information.

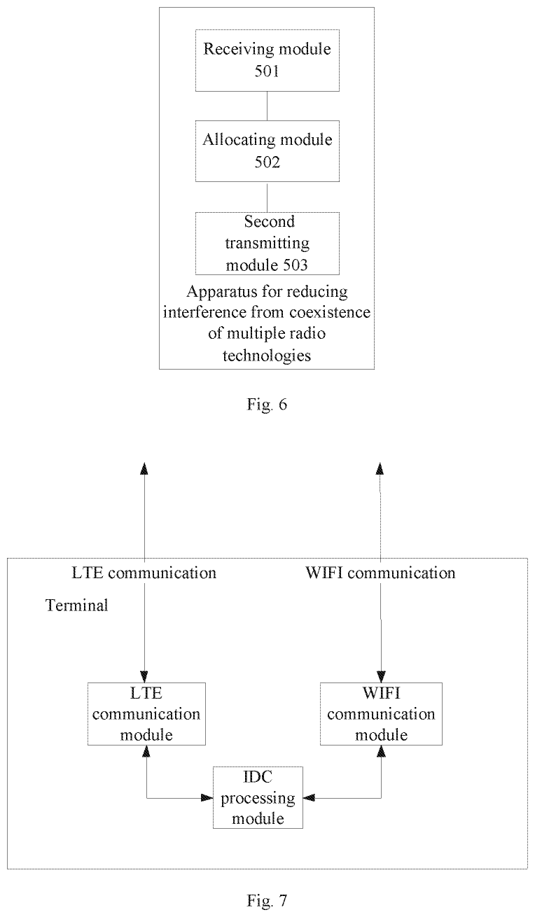

In the present embodiment, as shown in FIG. 6, the apparatus further includes:

a second transmitting module 503, configured to issue feedback information about the SR message to the terminal, the feedback information carrying the uplink resource allocated to the terminal.

In the present embodiment, the uplink resource allocated to the terminal by the network side is separated in time domain or frequency domain by an interval from time domain or frequency domain of other radio technologies other than the LTF/NR.

In practical applications, the receiving module 501 and the allocating module 502 may be a CPU, a DSP, an FPGA, or the like in a network device, and the second transmitting module 503 may be an antenna or the like.

An embodiment of the present disclosure further provides a terminal device which includes the apparatus for reducing interference from coexistence of multiple radio technologies as shown in FIGS. 3 and 4. The terminal device may be a mobile phone, a PDA, a smart handheld device, a laptop computer, a tablet computer, etc.

An embodiment of the present disclosure further provides a network device, such as a base station. The network device includes the apparatus for reducing interference from coexistence of multiple radio technologies as shown in FIGS. 5 and 6.

The present disclosure is described below in connection with a scenario embodiment.

The present embodiment considers interference with WIFI of a coexisting radio transmission technology when a terminal performs uplink communication of LTE cellular radio communication technology. To avoid such interference, the present embodiment provides the following solutions.

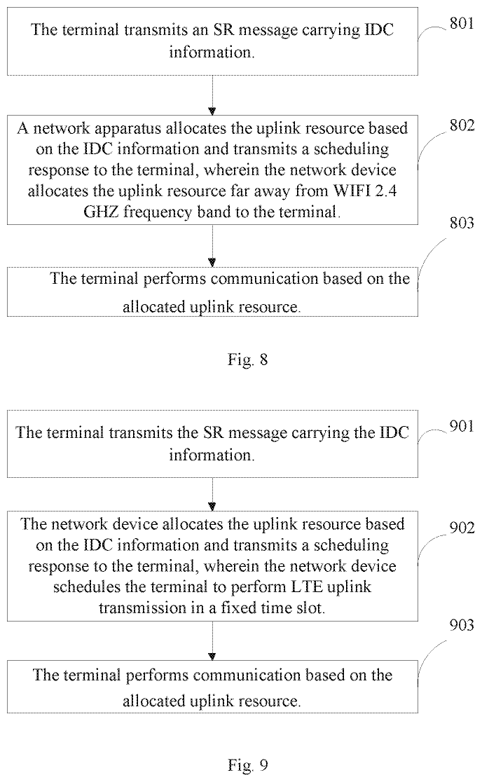

As shown in FIG. 7, a terminal A is provided with an LTE communication module and a WIFI communication module. At present, the terminal performs communications through both the LTE communication module and the WIFI communication module at the same time. In other words, LTE communication and WIFI communication coexist with each other. An IDC processing module is configured to handle interference between coexisting radio technology communications. When transmitting uplink data to an LTE eNB, the terminal needs to transmit an uplink scheduling request to request allocation of an uplink resource. An exemplary method flow is shown in FIG. 8 and includes the following steps.

In Step 801, the terminal transmits an SR message carrying IDC information.

Here, the terminal, based on its own communication state, finds that the WIFI module is also performing related data communication. Then, when the terminal transmits the uplink scheduling request, the IDC information is carried in the SR message to indicate that the terminal is performing WIFI data communication.

In Step 802, a network device allocates the uplink resource based on the IDC information and transmits a scheduling response to the terminal.

After receiving the SR message, the network device allocates the uplink resource far away from WIFI 2.4 GHZ frequency band to the terminal. The terminal utilizes this uplink resource for data transmission, so as to reduce interference with that coexisting radio technology.

Here, the uplink resource away from the WIFI 2.4 GHZ frequency band means that an RB (a physical resource block) in which the uplink resource is located is the one in the cell that has a larger frequency difference from WIFI 2.4 GHZ over all of the uplink resource blocks.

Alternatively, the uplink resource may also be one or more subcarrier resource in an RB away from the WIFI 2.4 GHz frequency band that has/have a larger frequency difference from 2.4 GHz.

In Step 803, the terminal performs communication based on the allocated uplink resource.

Alternatively, based on the above scenario, the present embodiment provides a further method for reducing interference from coexistence of LTE communication and WIFI communication. As shown in FIG. 9, the method includes the following steps.

In Step 901, the terminal transmits the SR message carrying the IDC information.

Here, the terminal, based on its own communication state, finds that the WIFI module is also performing related data communication. Then, when the terminal transmits the uplink scheduling request, the IDC information is carried in the SR message to indicate that the terminal is performing WIFI data communication.

In Step 902, the network device allocates the uplink resource based on the IDC information and transmits a scheduling response to the terminal.

After receiving the SR message, the network device schedules the terminal to perform LTE uplink transmission in a fixed time slot.

Here, the fixed time slot refers to a plurality of designated sub-frames. When the terminal performs LTE uplink transmission in these sub-frames, the terminal does not perform WIFI communication during the time of these sub-frames.

In Step 903, the terminal performs communication based on the allocated uplink resource.

It shall be appreciated by those skilled in the art that embodiments of the present disclosure may be provided as a method, a system, or a computer program product. The present disclosure may therefore adopt embodiments in the form of hardware embodiments, software embodiments, or embodiments combining both software and hardware. Furthermore, the present disclosure may take the form of a computer program product implemented on one or more computer usable storage media (including but not limited to, a magnetic disk memory, an optical memory, etc.) having computer-usable program codes.

The present disclosure is described with reference to flowcharts and/or block diagrams of methods, apparatuses (systems), and computer program products according to embodiments of the present disclosure. It shall be appreciated that each step and/or block in the flowcharts and/or the block diagrams, and combinations of steps/blocks in the flowcharts and/or the block diagrams, can be implemented by computer program instructions. These computer program instructions may be provided to a processor of a general-purpose computer, of a special-purpose computer, of an embedded processor, or of other programmable data processing devices to form a machine such that an apparatus configured to implement functions specified in one or more steps in the flowcharts and/or in one or more blocks in the block diagrams can be formed by way of instructions executed by the processor of the computer or other programmable data processing apparatuses.

These computer program instructions may also be stored in a computer readable memory capable of directing the computer or other programmable data processing apparatuses to function in a particular manner such that the instructions stored in the computer readable memory generate a product including an instruction device that implements the functions specified in one or more steps in the flowcharts and/or in one or more blocks in the block diagrams.

These computer program instructions may also be loaded onto a computer or other programmable data processing apparatuses such that a series of operational steps are performed on the computer or other programmable apparatuses to produce a computer-implemented process, such that the instructions executed on the computer or other programmable apparatuses provide steps for implementing the functions specified in one or more steps in the flowcharts and/or one or more blocks in the block diagrams.

The above description is only about preferred embodiments of the present disclosure, and is not intended to limit the protection scope of the present disclosure.

### INDUSTRIAL APPLICABILITY

According to the method for reducing interference from coexistence of multiple radio technologies, the terminal reports the IDC information to the network side, so that the network side schedules frequency domain or time domain of different radio technology communications in a separate manner based on the IDC information, thereby enabling simultaneous performing of different radio technology communications. In this way, the communication quality of each communication is guaranteed, and user experience is improved.

1. A method for reducing interference from coexistence of multiple radio technologies, wherein the method comprises:
Setting up, by a terminal, an uplink scheduling request SR message, the SR message carrying in-device coexistence IDC information, the IDC information being configured for a network side to allocate an uplink resource to the terminal; and
transmitting, by the terminal, the SR message.

2. The method according to claim 1, wherein the IDC information includes one or more of:
in-device coexistence indication information, receiving frequency domain information of other in-device coexisting radio technologies other than LTE/NR, receiving time domain information of other in-device coexisting radio technologies other than the LTE/NR, transmitting frequency domain information of other in-device coexisting radio technologies other than the LTE/NR, transmitting time domain information of other in-device coexisting radio technologies other than the LTE/NR, in-device coexisting time domain allocation information, in-device coexisting frequency domain allocation information.

3. The method according to claim 1, wherein after the terminal transmits the SR message, the method further comprises:
receiving, by the terminal, feedback information about the SR message issued from the network side, and performing, by the terminal, communication based on the uplink resource allocated by the network side which is carried in the feedback information.

4. The method according to claim 3, wherein the uplink resource allocated to the terminal by the network side is separated in time domain or frequency domain by an interval from time domain or frequency domain of other radio technologies other than LTE/NR.

5. A method for reducing interference from coexistence of multiple radio technologies, wherein the method comprises:
receiving, by a network side, an uplink scheduling request SR message, the SR message carrying in-device coexistence IDC information; and
allocating, by the network side, an uplink resource to a terminal based on the IDC information.

6. The method according to claim 5, wherein after the network side allocates the uplink resource to the terminal, the method further comprises:
issuing, by the network side, feedback information about the SR message to the terminal, wherein the feedback information carries the uplink resource allocated to the terminal.

7. The method according to claim 5, wherein the uplink resource allocated to the terminal by the network side is separated in time domain or frequency domain by an interval from time domain or frequency domain of other radio technologies other than LTF/NR.

8. A system for reducing interference from coexistence of multiple radio technologies, comprising a terminal device including a terminal side apparatus for reducing interference from coexistence of multiple radio technologies and a network device including a network side apparatus for reducing interference from coexistence of multiple radio technologies, wherein the terminal side apparatus comprises:
a setting up module, configured to set up an uplink scheduling request SR message, the SR message carrying in-device coexistence IDC information, the IDC information being configured for a network side to allocate an uplink resource to a terminal, and
a first transmitting module, configured to transmit the SR message,
wherein the network side apparatus comprises:
a receiving module, configured to receive an uplink scheduling request SR message, the SR message carrying in-device coexistence IDC information, and
an allocating module, configured to allocate an uplink resource to a terminal based on the IDC information.

9. The system according to claim 8, wherein the terminal side apparatus further comprises:
a receiving and processing module, configured to receive feedback information about the SR message issued from the network side, and perform communication based on the uplink resource allocated by the network side which is carried in the feedback information.

10. The system according to claim 9, wherein the uplink resource allocated to the terminal by the network side is separated in time domain or frequency domain by an interval from time domain or frequency domain of other radio technologies other than LTE/NR.

11. (canceled)

12. The system according to claim 44, wherein the network side apparatus further comprises:
a second transmitting module, configured to issue feedback information about the SR message to the terminal, wherein the feedback information carries the uplink resource allocated to the terminal.

13. The system according to claim 12, wherein the uplink resource allocated to the terminal by the network side is separated in time domain or frequency domain by an interval from time domain or frequency domain of other radio technologies other than LTE/NR.

14. (canceled)

15. (canceled)

16. A storage medium configured to store program codes which are used for performing the method according to claim 1.

17. The method according to claim 6, wherein the uplink resource allocated to the terminal by the network side is separated in time domain or frequency domain by an interval from time domain or frequency domain of other radio technologies other than LTE/NR.
